(19) United States
(12) Patent Application Publication
(10) Pub. No.: US 2018/0206622 A1
(43) Pub. Date: Jul. 26, 2018

(54) CLEANING BRUSH

(71) Applicant: Chris Wilson, Chattanooga, TN (US)

(72) Inventor: Chris Wilson, Chattanooga, TN (US)

(21) Appl. No.: 15/881,129

(22) Filed: Jan. 26, 2018

Related U.S. Application Data
(60) Provisional application No. 62/450,830, filed on Jan. 26, 2017.
(60) Provisional application No. 62/456,153, filed on Feb. 8, 2017.

(51) Int. Cl. A46B 5/00; A46B 7/04; B60S 3/00

(52) U.S. Cl. CPC A46B 5/0041; A46B 5/0012; A46B 2200/3046; A46B 7/044; B60S 3/008; A46B 5/0095

(57) ABSTRACT

A cleaning brush including a body including a first member and a second member opposing the first member. The first member hingedly coupled to the second member. A first bristle portion coupled to the first member. A second bristle portion coupled to the second member. The first bristle portion and the second bristle portion forming a space therebetween.

### CROSS REFERENCE TO RELATED APPLICATIONS

This patent application claims the benefit of U.S. Provisional Patent Application Ser. No. 62/450,830, filed on Jan. 26, 2017, and U.S. Provisional Patent Application Ser. No. 62/456,153, filed on Feb. 8, 2017. The entire disclosures of the above patent applications are hereby incorporated herein by reference in its entirety.

### FIELD OF THE INVENTION

The present invention relates to a cleaning brush and, more particularly, to a detailing cleaning brush for automobile seatbelts.

### BACKGROUND OF THE INVENTION

Cleaning seatbelts in automobiles is a labor intensive procedure. Typically, the detailer buckles the seatbelt and pulls it away from the seat. A cleaning fluid is then sprayed on the seatbelt. The seatbelt is then released and allowed to contact the seat. A hand brush is used to scrub the cleaning fluid into the seatbelt to remove dirt or stains. This causes dirt and stains and fluids to soak through the seatbelt to a reverse side thereof and/or onto the seat that the seatbelt is contacting. The pulling, spraying, scrubbing steps are then repeated on the reverse side of the seatbelt. The process is then repeated until the seatbelt is adequately cleaned. Due to overspray and contact of the seatbelt with the seat, the seat must also be cleaned or re-cleaned from the seatbelt cleaning process.

It would be desirable to develop a cleaning tool for cleaning a seatbelt that minimizes an effort required to clean the seatbelt and that minimizes unintended spraying or transfer of fluids or dirt from the seatbelt onto surrounding areas.

### SUMMARY OF THE INVENTION

Concordant and congruous with the present invention, a cleaning tool for cleaning a seatbelt that minimizes an effort required to clean the seatbelt and thaminimizes unintended spraying or transfer of fluids or dirt from the seatbelt onto surrounding areas has surprisingly been discovered.

According to one embodiment of the disclosure, A cleaning brush including a body including a first member and a second member opposing the first member. The first member hingedly coupled to the second member. A first bristle portion coupled to the first member. A second bristle portion coupled to the second member. The first bristle portion and the second bristle portion forming a space therebetween.

According to another embodiment of the disclosure, A cleaning brush includes a body having an open end and a pivot end. The body including a first member and a second member opposing the first member. The first member having a support and a hinge arm extending outwardly from the support of the first member and a second member having a support and a hinge arm extending outwardly from the support of the second member. The hinge arm of the first member hingedly coupled to the hinge arm of the second member. A first bristle portion slideably received in the support of the first member. A second bristle portion slideably received in the support of the second member.

According to an alternate embodiment of the disclosure, a method for cleaning a seatbelt comprising the steps of: providing a cleaning brush including a body, the body having a first member and a second member biasing away from the first member by a biasing member; coupling a first bristle portion into the first member; coupling a second bristle portion into the second member, the second bristle portion spaced from the first bristle portion; inserting a seatbelt intermediate the first bristle portion and the second bristle portion; and applying a force to the body to contact the seatbelt with the first bristle portion and the second bristle portion, the bforce greater than a biasing force of the biasing member.

### BRIEF DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a front perspective view of a cleaning brush according to an embodiment of the invention;

FIG. 2 is an enlarged front perspective view of a hinge pin of the cleaning brush highlighted by the circle in FIG. 1;

FIG. 3 is a right side elevational view of the cleaning brush of FIG. 1; and

FIG. 4 is a right side elevational view of a cleaning brush according to another embodiment of the invention.

### DETAILED DESCRIPTION OF EXEMPLARY EMBODIMENTS OF THE INVENTION

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

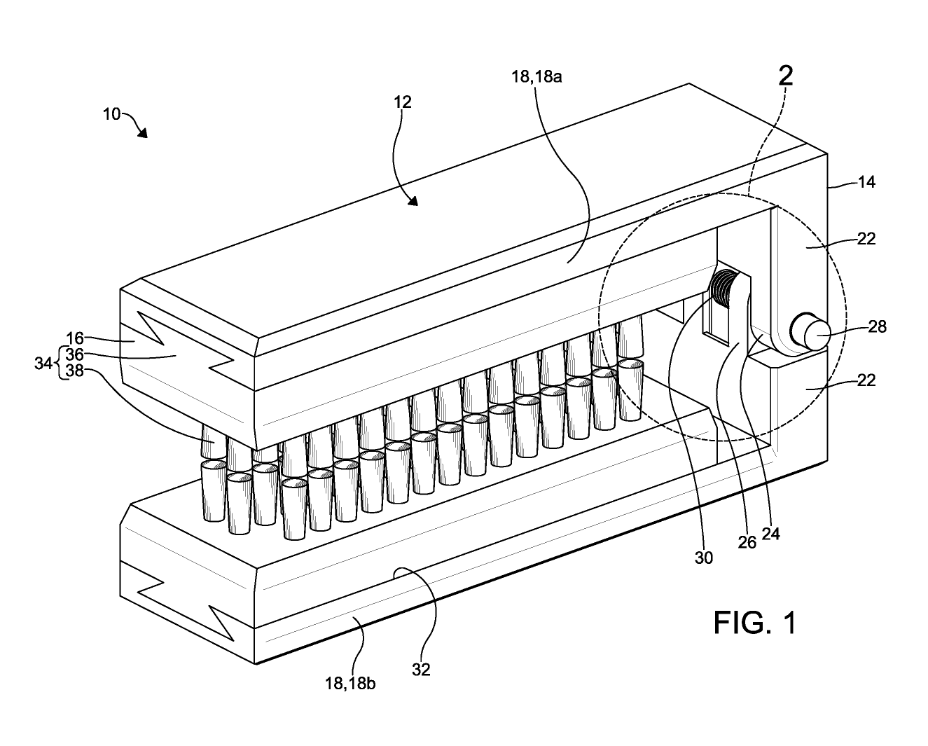

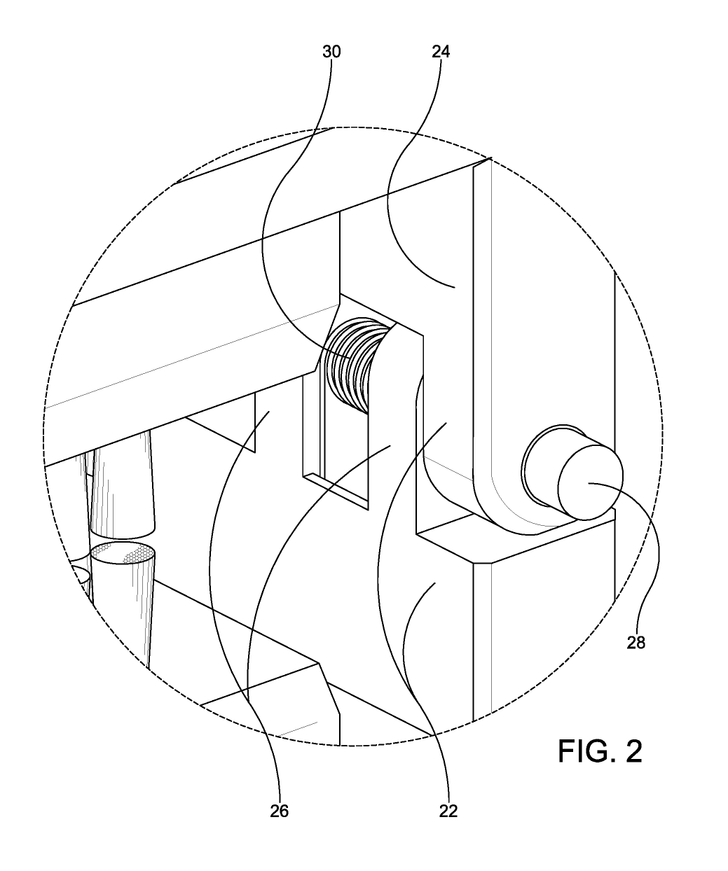

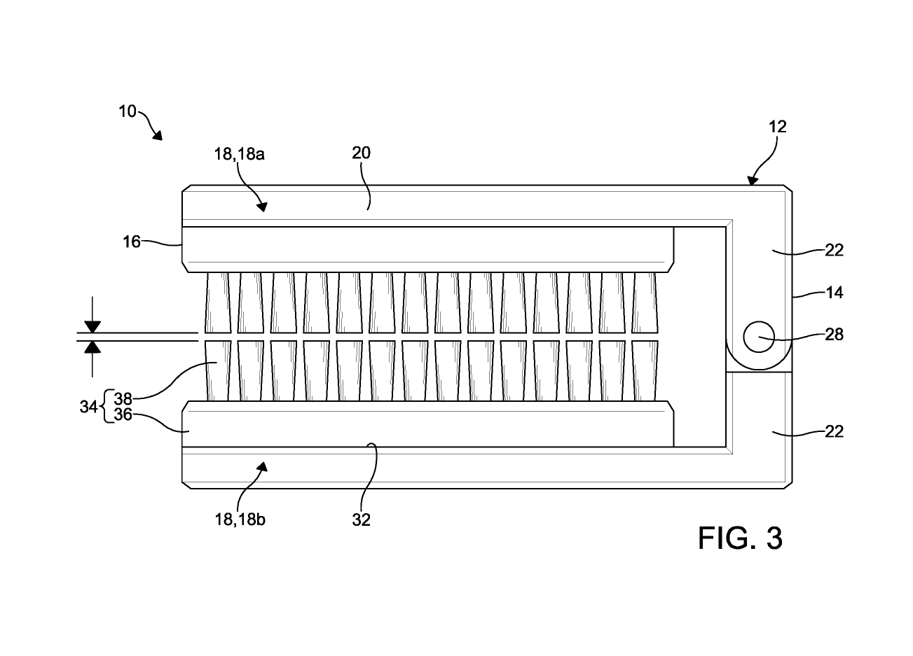

FIGS. 1-3 show an embodiment of a cleaning brush 10 according to the invention. The brush 10 has a body 12 with a pivot end 14 (a back thereof) and an open end 16 (a front thereof) opposing the pivot end 14. The body 12 is formed from a pair of opposing members 18, or a first member 18a and a second members 18b. The body 12 is formed form a metal, such as aluminum, but may be formed from another material as desired (e.g., a plastic, a rubber, a ferous metal, another metal, an alloy, or a composite material, for example). The body 12 is substantially U-shaped.

The members 18 are hingedly connected at the pivot end 14 of the body 12. The members 18 pivot with respect to each other about the pivot end 14. Each of the members 18 includes an elongate support 20 with a substantially rectangular cross-sectional shape and a hinge arm 22 extending from the support 20 at the pivot end 14 thereof. The hinge arm 22 extends substantially perpendicular with respect to the support 20. The hinge arm 22 of the first member 18a includes a clevis 24 formed at distal end thereof and the hinge arm 22 of the second member 18b includes a pair of prongs 26 extending from a distal end thereof. The clevis 24 of the hinge arm 22 of the first member 18a receives the prongs 26 of the hinge arm 22 of the second member 18b to engage the first member 18a to the second member 18b.

A hinge pin 28 extends through the clevis 24 and prongs 28 to hingedly coupled the members 18 to each other. It is understood, the members 18 can be hingedly coupled to each other by other hinge configurations, if desired. The hinge pin 28 includes a biasing member 30, such as a spring, for example, engaging each of the hinge arms 22. The biasing member 30 is configured to bias the first member 18a away from the second member 18b such that inner surfaces of the supports 20 are substantially parallel to each other. The supports 20 can be pivoted towards each other with forces greater than the biasing force of the biasing member 30.

The body 12 includes bristle portions 34, and the bristle portions 34 are positioned to face one another. The bristle portions 34 include a receptacle 36 and bristles 38. The bristle portions 34 are slidably engaged with the respective supports 20 via a dovetail system wherein the bristle portions 34 include the tenons and the support 20 the mortises. It is understood that the support 20 may include the tenons and the bristle portions 34 the mortises, as desired. In other embodiments, the bristle portions 34 are releasably connected to the supports 20 by another means such as hook-and-loop tape, snaps, an adhesive, or other mechanical interlocking mechanism.

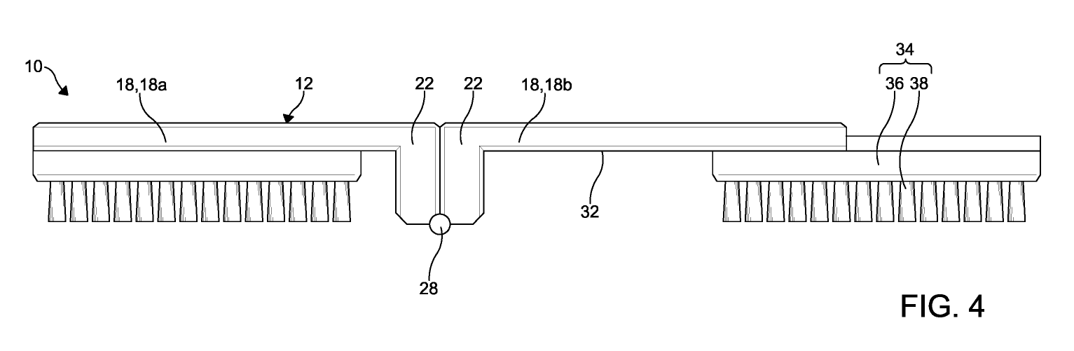

In the embodiment illustrated, the members 18 may not be opened so that the members 18 may be disposed side-by-side in the same line. However in other embodiments, shown in FIG. 4, such an opening is allowed. In the embodiment illustrated in FIG. 4, the hinge pin 28 is disposed at a central exterior portion of the hinge arms 22 so the members 18 can be disposed side-by-side in the same line. According to this alternate embodiment, the hinge pin 28 can be removed to accommodate the side-by-side arrangement and replaced to secure the members 18 in the side-by-side arrangement.

In use, the bristle portions 34 are disposed in respective ones of the members 18. The bristle portions 34 and/or a seatbelt is sprayed with a cleaner. The seatbelt is disposed in between the bristle portions 34 through the open end 16 of the cleaning brush 10 in the space formed between the bristle portions 34. The supports 20 of the cleaning brush 10 is then squeezed by a user thereof so that the bristle portions 34 contact both sides of the seatbelt at the same time. The user applies a force greater than the force of the biasing member 30. The user then causes the bristles 38 to scrub the seatbelt with a back-and-forth motion, thereby cleaning both sides of the seatbelt at the same time. The seatbelt is then removed from the brush 10 through the open end 16. If further cleaning is required, the process is repeated. Alternatively, the bristle portions 34 (as shown in FIG. 4) can be removed. The bristle portions 34 of the cleaning brush 10 may be removed and replaced with finer bristles, softer bristles, more rigid bristles, or bristles made of a different material (e.g., a plastic, a rubber, a metal, or a composite) for further cleaning procedures.

In other embodiments of the disclosure, the removable bristle portions 34 may be replaced with a sponge (real or artificial), a body having a sticky material, a carpet brush, for example, a lint-roller-like tape, or cloth insert, a pet hair brush, or other known material or brush used for cleaning (e.g., a vent detailing brush or a brush to clean tires or rims). Similarly, one or more of the removable bristle portions 34 may be replaced with a graspable handle ergonomically designed to be held in a user's hand or an insert that merely fills the slot/groove in which the removable bristle portions 34 are disposed.

In another embodiment of the disclosure, the body 12 of cleaning brush 10 is formed from a unitary material and is formed from injection molding, rotational molding, or any other suitable process for forming an object from a single piece of material rather than from multiple pieces fixed together. The material may be flexible and able to be squeezed to slightly deform the cleaning brush 10 and move the bristles 38 (or other cleaning inserts) closer together, as desired.

In yet another embodiment of the disclosure, not shown, the two members 18 of the body 12 may be placed in a linear alignment with the bristle portions 34 thereof on opposite sides of the linear cleaning brush, as desired.

While the cleaning of a seatbelt is described herein, the cleaning brush 10 may be used to clean any material or article or portion thereof that may fit between the bristle portions 34, as desired. Furthermore, the various embodiments of the invention and features thereof may be combined with other features of other embodiments, as desired.

From the foregoing description, one ordinarily skilled in the art can easily ascertain the essential characteristics of this invention and, without departing from the spirit and scope thereof, can make various changes and modifications to the invention to adapt it to various usages and conditions.

I claim:

1. A cleaning brush comprising:
a body including a first member and a second member opposing the first member, the first member hingedly coupled to the second member; and
a first bristle portion coupled to the first member; and
a second bristle portion coupled to the second member, the first bristle portion and the second bristle portion forming a space therebetween.

2. The cleaning brush of claim 1, wherein the first member includes a support for coupling to the first bristle portion and a hinge arm extending outwardly from the support.

3. The cleaning brush of claim 2, wherein the hinge arm of the first member includes a clevis formed a distal end thereof.

4. The cleaning brush of claim 1, wherein the second member includes a support for coupling to the second bristle portion and a hinge arm extending outwardly from the support.

5. The cleaning brush of claim 4, wherein the hinge arm of the second member includes a pair of prongs extending outwardly from a distal end thereof.

6. The cleaning brush of claim 1, wherein the first bristle portion is slideably received by the first member and the second bristle portion is slideably received by the second member.

7. The cleaning brush of claim 1, wherein a hinge pin hingedly couples the first member to the second member.

8. The cleaning brush of claim 1, wherein a biasing member is disposed between the first member and the second member to bias the first member away from the second member to form the space between the first bristle portion and the second bristle portion.

9. The cleaning brush of claim 1, wherein the first member and the second member are adaptable to be positioned side-by-side in a linear alignment.

10. The cleaning brush of claim 1, wherein the body is substantially U-shaped.

11. The cleaning brush of claim 1, wherein the body is formed from a metal.

12. A cleaning brush comprising:
a body having an open end and a pivot end, the body including a first member and a second member opposing the first member, the first member having a support and a hinge arm extending outwardly from the support of the first member and a second member having a support and a hinge arm extending outwardly from the support of the second member, the hinge arm of the first member hingedly coupled to the hinge arm of the second member;
a first bristle portion slideably received in the support of the first member; and
a second bristle portion slideably received in the support of the second member.

13. The cleaning brush of claim 12, wherein the first bristle portion is received in the support of the first member via a dovetail system and the second bristle portion is received in the support of the first member via a dovetail system.

14. The cleaning brush of claim 12, wherein the first member pivots with respect to the second member about a hinge pin.

15. The cleaning brush of claim 12, wherein each of the first bristle portion and the second bristle portion include a receptacle receiving a plurality of bristles.

16. The cleaning brush of claim 12, wherein a space is formed between the first bristle portion and the second bristle portion.

17. The cleaning brush of claim 16, wherein a biasing member is positioned intermediate the first member and the second member, the biasing member biasing the first member from the second member.

18. A method for cleaning a seatbelt comprising the steps of:
providing a cleaning brush including a body, the body having a first member and a second member biasing away from the first member by a biasing member;
coupling a first bristle portion into the first member;
coupling a second bristle portion into the second member, the second bristle portion spaced from the first bristle portion;
inserting a seatbelt intermediate the first bristle portion and the second bristle portion; and
applying a force to the body to contact the seatbelt with the first bristle portion and the second bristle portion, the force greater than a biasing force of the biasing member.

19. The method of claim 18, further comprising the step of replacing at least one of the first bristle portion and the second bristle portion with a secondary bristle portion.

20. The method of claim 18, further comprising the step of positioning the first member in substantially linear alignment with the second member.
